(19) United States
(12) Patent Application Publication
(10) Pub. No.: US 2008/0250158 A1
(43) Pub. Date: Oct. 9, 2008

(54) Methods and Systems for Disseminating Information to Ensure Recipient Retention

(75) Inventor: Walter Mansell, Boxford, MA (US)

Correspondence Address: ANTOINETTE G. GIUGLIANO, P.C.;DBA AGG Intellectual Property Law, 100 Cummings Center, Suite 454C, Beverly, MA, 01915, US

(73) Assignee: Watershed Networks, Inc.

(21) Appl. No.: 11/697,290

(22) Filed: Apr. 5, 2007

(51) Int. Cl. G06F 15/173

(52) U.S. Cl. 709/238

(57) ABSTRACT

The present invention relates to methods, systems and apparatus of disseminating information about a topic to more than one recipient. The information includes a plurality of informational segments (e.g., ticklers), wherein an informational segment has one or more pieces of media, an image, text, or any combination thereof. The methods involve providing an electronic communication to said recipients, wherein the electronic communication includes the informational segment or a link thereto, and wherein the informational segment lasts about 3 minutes or less. The methods involve obtaining feedback from the user regarding the informational segment; and repeating these steps periodically until each informational segment is provided to more than one recipient. The informational segment includes a comical element, informational element, and a request for feedback.

### BACKGROUND OF THE INVENTION

Corporations often disseminate important information to a large number of employees, especially when significant changes occur within the company. Examples of such changes include mergers, acquisitions, changes in upper level management/officers, or in an effort complete large projects. There are instances in the life of certain company where there is the need to address complex issues with employees. A challenge occurs in disseminating information and ensuring that the recipient has actually heard the information, understood it and retained it. It can be particularly challenging when a large volume of information has to be retained by a large number of people. Furthermore, retention of information by employees is advantageous because certain studies have shown that when a complex issue is presented to a large group of people, they will invariably devise a course of action which is better and more relevant that one produced by a small group of experts.

Hence a need exists for methods and systems to disseminate information to ensure retention by the recipient. A further need exists to ensure retention of a large quantity of information to a significant number of recipients/employees. Yet a further need exists to provide an informational dissemination system that engages and encourages recipients to participate in a course of action.

### SUMMARY OF THE INVENTION

The present invention relates to methods of disseminating information about a topic to more than one recipient, wherein the information includes a plurality of informational segments (e.g., tickler). An informational segment includes one or more pieces of media (e.g., audio, video), an image, text, or any combination thereof. The steps of the methods involve providing an electronic communication to the recipients, wherein the electronic communication has the informational segment or a link thereto. The informational segment is designed to lasts about 3 minutes or less (e.g., about 2½, 2, 1½, 1 minute). The steps also include obtaining feedback from the user regarding the informational segment. The steps are repeated periodically until all of the informational segments have been disseminated. The informational segment includes a comical element, informational element, and a request for feedback. The request for feedback embodies a series of one or more questions regarding the information conveyed. The information to be disseminated can include at least about 20 (e.g., about 25, 30, 35, 40, 45, or 50) informational segments. Each informational segment conveys an aspect of the topic. The informational segments are provided periodically (e.g., daily, every few days, biweekly, weekly, or a combination thereof) to recipients. In an embodiment, answers to questions by recipients are assessed to determine the degree of retention of the information, wherein one or more correctly answered questions indicates retention. In the event that retention is not obtained for an informational segment, then an embodiment of the invention includes modifying one or more informational elements of one or more segments to reconvey information not retained by one or more recipients. An aspect of the present invention includes logging in, either automatically or manually, of the recipient. In the case where the link to the informational segment is provided, the method further includes engaging the link by the recipient; and automatically logging in the recipient.

The present invention further includes computer systems or apparatus for disseminating information about a topic to more than one recipient. The system pertains to a source of informational data (e.g., a plurality of informational segments, wherein an informational segment includes one or more pieces of media, an image, text, or any combination thereof), and recipient data (e.g., name, login identification, destination address for the electronic communication, and any combination thereof). The system further includes a processor, coupled to the source, wherein the processor carries out the steps described herein. In particular, the steps of the system include providing an electronic communication having the informational segment or a link thereto to the recipients; and recording feedback from the user regarding the informational segment. The system repeats the steps periodically until each informational segment is provided to the recipients, as described herein. An output device (e.g., a computer screen, personal digital assistant (PDA), media player (ipod, mp3 player)) that provides the informational segment is also included by the computer system or apparatus. The address of electronic communication can be an email address or mobile phone number.

The present invention includes several advantages. The present invention provides a company with a method of disseminating a lot of information to address a complex subject to a large number of employees in an efficient, fun and easy way. The present invention enables companies to address complex problems and issues in an unobtrusive and non-threatening manner that does not distract from normal daily operations. Furthermore, the present invention allows companies to leverage the strength of their employees by informing them on the rationale for organizational change in preparation for the new environment.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic showing, in an embodiment, the flow of the methods of the tickler of present invention.

FIG. 2 is a block diagram employing the methods of disseminating information of the present invention.

FIGS. 3A-3E is a printout of the source code used to carry out an embodiment of the present invention.

### DETAILED DESCRIPTION OF THE INVENTION

A description of preferred embodiments of the invention follows.

The present invention relates to methods and systems for disseminating information to more than one recipient, and preferably to a large number of recipients. The present invention is designed, in one aspect, to convey a large amount of information in a corporate environment to not only inform employees, but to reasonably ensure that the employees understand and retain the information. The methods further include a comedic element to initiate discussion and participation by and among employees.

Telecom companies are a typical type of company for which the present invention can be employed. Telecom companies are often known for undergoing change, including mergers, takeovers, buyouts, acquisitions, and changes in senior management, etc. Such companies can be very large, and employees often have concerns about their jobs, their responsibilities, corporate plans and the like. In such situations, corporations will want to provide information to their employees about the topic at hand. Busy employees are unlikely to take the time to read and fully comprehend a large amount of information that is provided to them all at once. Hence, the present invention provides information in short informational segments over a period of time and does so to encourage retention of information by the employees, and to spark discussion and participation.

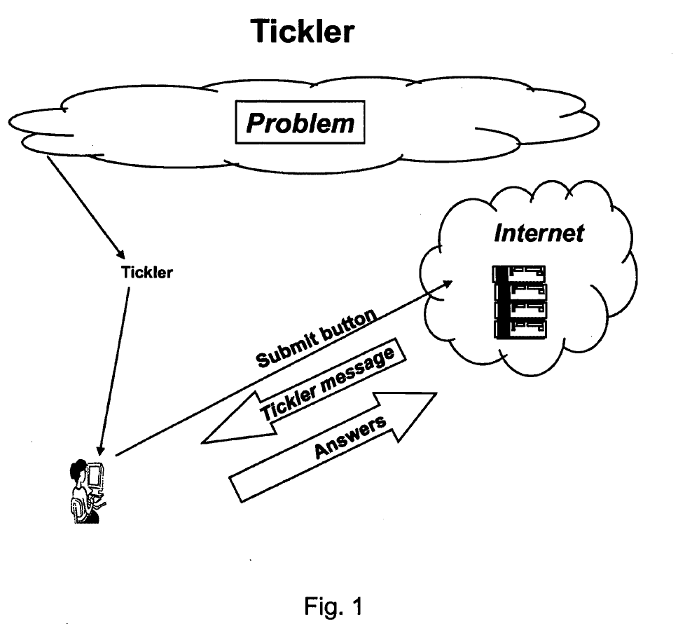

Referring to FIG. 1, the present invention pertains to disseminating information about a topic to more than one recipient, wherein the information is made up of a series or plurality of short informational segments. “Disseminating” information refers to the dispersal or distribution of information. The dissemination is performed by providing an electronic communication to the recipients. An electronic communication refers to a communication transmitted with the use of computers and/or telecom equipment. Examples of an electronic communication include emails, text messages, webpages, and podcasts. Any form of electronic communications now known or developed in the future can be used to provide the information.

Information includes a number of informational segments, which is also referred to as a “tickler” and the terms are used interchangeably herein. The informational segments are designed to be relatively short and focused on a specific piece of the overall topic (e.g., a merger, a takeover, etc.) to be conveyed. In an embodiment, the informational segment lasts approximately about 3 minutes or less (e.g., about 2 minutes, 1½ minutes, 1 minute, 45 seconds). Each informational segment is designed to be short to increase participation by the recipients by taking little time out of their day.

A series or plurality of informational segments comprise the overall message or topic to be conveyed. For example, the overall topic can be about a merger of one company with another. Each informational segment contains a small, but focused part of the overall message, e.g., the sales department of one company will be combined with the sales department of the second company, when it will occur, and how. The information to be disseminated can be made up of at least about 15 informational segment and preferably about 20 (e.g., about 25, 30, 35, 40, 45, 50, 55 or more) informational segments. The information to be disseminated can include as many informational segments necessary to convey the entire message.

The informational segments can be transmitted to recipients periodically. Periodically refers to the transmission of the electronic communication having the informational segment (e.g., a tickler message or tickler email) twice a day, daily, every few days, bi-weekly, weekly. In an embodiment, the informational segment is transmitted daily during the business week (e.g., Monday through Friday). In another embodiment, a tickler is sent daily during the business week over about a 6-7 week period.

The informational segments, in an embodiment, include a comical element, informational element, and a request for feedback. The comical element can relate to any text, image, audio to capture the attention of the recipient or gain the interest of the recipient. Examples of comical elements include jokes, comical, interesting, or startling facts or images. The comical element is not only used to capture the attention of the recipient, but it is also used to induce conversation between recipients. Recipients are more likely to open the email, listen to it and discuss informational segments among one another if the segment includes a comical aspect. In an embodiment, the comical element is present at the beginning of the informational segment, but can be present throughout the segment, integrated within the segment, or at the end of the segment, or any combination thereof. The comical element is optional.

In an embodiment, the electronic communication of the present invention is sent simultaneously, or essentially simultaneously to the recipients. Since the email is arriving to the recipients around the same time, it is more likely to spur discussions within the work groups. This process will also enable employees to examine the issues from their perspective within the company. For example people in the billing department will view the changes differently from those in the sales department, or operations department. These internal discussions will become a form of viral marketing so that suggestions and ideas can be socialized and percolated to the top.

The informational segments of the present invention further include the informational element. As described herein, the informational element includes, in part, the informational content to be conveyed to the recipient. The information is a focused portion of the overall message, as described herein. The informational content can be the same for all recipients, or different depending on the class of persons receiving it. In a certain embodiment, providing the same informational content is advantageous so that employees can more easily discuss the content. In another embodiment, different informational content can be provided to recipients having differing positions or responsibilities. By the way of an example, a manager whose department is being eliminated can receive a tickler having different informational content than an employee of a department being merged with another. The informational element further includes, in one aspect, a summary or some overlap with one or more informational elements transmitted in previous ticklers.

The segments also involve a request for feedback from the user. The request can be in any form so long as it ascertains whether the recipient listened and understood the informational content. The request can be in the form of one or more questions (e.g., multiple choice, true/false), fill in the blanks, request for a short summary, and the like. Preferably, the answers to the questions can be analyzed by software to determine if the answer is correct. In an embodiment, the correct answers are conveyed to the recipient so that the recipient can learn from any incorrect answers, or reinforce that the recipient did understand the concept being conveyed.

The request for feedback allows one to determine if recipients are comprehending the information being provided. In the event that a percentage of recipients do not understand the message being conveyed, then future ticklers can be modified, or additional ticklers can be added to the overall program of ticklers to ensure the information is received or understood. For example, if greater than about 15% (e.g., about 20%, 25%, 30%, 35%, 40%, 45%, or 50%) of the recipients answer the majority of the questions incorrectly, then one or more additional ticklers providing the content, perhaps in a different way, can be provided. An aspect of the present invention includes a correction mechanism by adding additional informational segments, and/or modifying existing segments to increase retention. Retention of the information in the informational segment refers to the recipients' ability to understand the information so as to be able to answer questions about the information correctly.

In an embodiment, the questions or request for feedback can also induce a competitive environment. Teams can be formed and results of the teams can be compared to one another to determine which team is better retaining the information. A greater amount of questions answered correctly by a first group of recipients, as compared to a second group indicates, indicates the first group is winning. Rewards can be provided to the winning teams. Competition between two or more groups of recipients further increases participation through peer pressure for the group to pay attention and answer the questions correctly. Online access of the team results can be provided in an embodiment so that recipients can view their team's progress.

Recipient, as described herein, refers to a person receiving the informational segment. An example of a recipient is an employee or consultant of the company. The present invention relates to sending the electronic communication to more than one person, and in an embodiment to a large number of people. The number of recipients ranges from 2 persons to about 50,000 persons (e.g., between about 10,000 and 40,000, and preferably about 20,000 and 30,000). The recipients include various employees in a corporate environment, and if desired, can be divided into classes or teams, as described herein. Classes can be formed, as desired by the client, and include, e.g., by job hierarchy, department, responsibility, area, etc.

The informational segment includes, in an embodiment, text, images, one or more pieces of media, links, webpages and any other format to provide the informational element, comical element or request for feedback, as described herein. The informational segment includes any format known or development in the future, and can include any combination of the formats recited above. Images include uploaded photographs, pictures, sketches, symbols, and any graphical representation. Examples of media include images, audio and/or video files. Video includes streaming video, movie files, and any format that includes a series of frames or images. An informational segment can contain a file having one or more images, video, movie, and/or audio data. Informational segments can be made up of one or more files that are in any format now known e.g., jpeg, pdf, tiff, avi, .mov, .mpg, mp3, mp4, .png, gif, psd, and the like or developed in the future.

The present invention involves providing an electronic communication (e.g., an email) to the recipients. In an embodiment, the email contains a link to the informational segment. The link can be embedded in text, a button, symbol, and the like. The link directs the recipient to a webpage on a server, wherein the webpage has the tickler. When the user clicks on the link, the recipient is automatically logged in. The user can be automatically logged in using their user ID, email or other unique identifier. In another embodiment, the user has to enter a username and/or password. In FIG. 1, the tickler is provided to the recipient, and the recipient clicks on the “submit button.” This action logs the user in automatically (e.g., using their sent address as the login ID), and the recipient's web-browser opens the webpage with the tickler message. The recipient listens, views and/or reads the tickler, and then answers the questions. The answers of the questions are transmitted to the server. The answers are recorded for the recipient in a library, index or database. Such data is stored in methods known in the art or later developed.

In another embodiment, the electronic communication is provided with the actual tickler, rather than a link to the tickler. The text, media files (e.g., video and/or audio files), images, or HTML page is transmitted as an attachment, imbedded into the email, incorporated into the email, or otherwise made part of the email. In such a case, the user opens the email, listens, views, and/or reads the tickler, and answers the question. In an embodiment, when the recipient opens the email message the audio plays automatically and the contents of the message are displayed. When the recipient indicates that she or he is done, e.g., by clicking on the “Submit button,” the information along with the recipient's logon information, as described herein, is transmitted to the server and stored. If teams are made to induce competition between them, then the methods further include associating the answers with a particular team, and comparing the results of one team to others.

Yet another embodiment includes modifying the web-browser so that the recipient automatically goes to the tickler web-page. For example, the options or settings of web-browse are modified so that the tickler page is shown when the browser is first opened. The recipient, once on the page, can log in, view, read, or listen to the ticker, answer the questions and submit the page. Upon hitting the “submit” button, the answers for that recipient are saved or recorded. The server with the informational segments can change periodically (e.g., daily) to display a different tickler message. In an embodiment, the tickler will display the contents of the message and the audio stream will begin automatically. Each user will respond to the questions by typing in their user identification, e.g., email address as a username. Information will be associated with the appropriate team, in the case that teams are created within the company, as described herein.

The present invention further includes systems and computer apparatus to carry out the steps described herein. The systems and apparatus include a source of data. The source data includes the informational segments, and the electronic destination address for the recipient. The informational segments, or ticklers can be placed on a server along with the recipients' email addresses. The electronic destination address can be an email or cell phone number, or any other address that allows one to receive an email.

A processor allows for software to carry out the steps of the software. Software used to create the tickler includes any software that allows one to create a web page. The methods described herein utilize a graphical user interface (GUI), or an interface known in the art, or later developed. Software that can be used to create, in part or in whole, such an interface and perform the steps described herein includes, e.g., HTML, AJAX (Asynchronous Java and XML) software, DreamWeaver, and FLASH software, javascript, php, scripts, css, asp, cold fusion, jsp ruby, ruby on rails, email applications, and the like. An interface refers to any mechanism by which an external user via a computer, media player, mobile phone, PDA can obtain and provide data described herein. Audio recordings, in an embodiment, are compressed using windows media (version 9.0 or later) compression. In one aspect, the web server is a Windows-based server but can work on a Linux server, or any other server known or developed in the future. Internet browsers (e.g., Internet explorer or Netscape) can be used to carry-out certain aspects of the invention.

The present invention encompasses methods for storing the recipient's feedback to the questions, as described herein. A database refers to a collection of two or more pieces of stored data. Data can be stored in a manner, and in a mode known in the art, or developed in the future. Examples of types of databases that store user generated metadata and links include MY SQL, SQL, and Oracle. The data being stored, whether physically together, or associated with one another, includes the recipient's user identification, the recipient's feedback, the ticklers and any portions thereof, any other information useful for carrying out the invention, and any combination thereof.

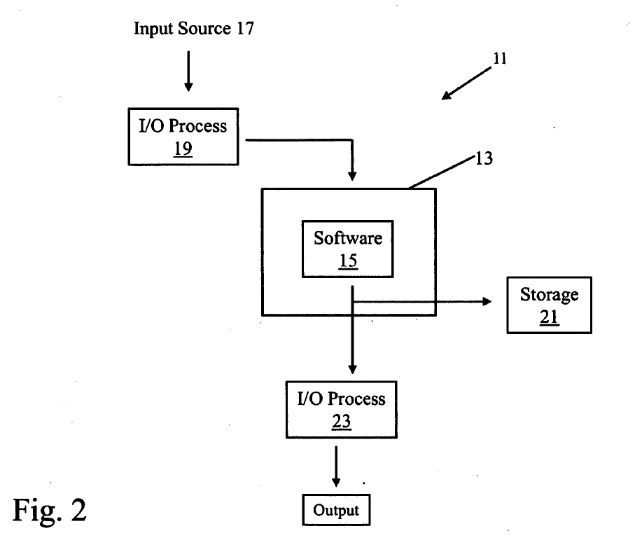

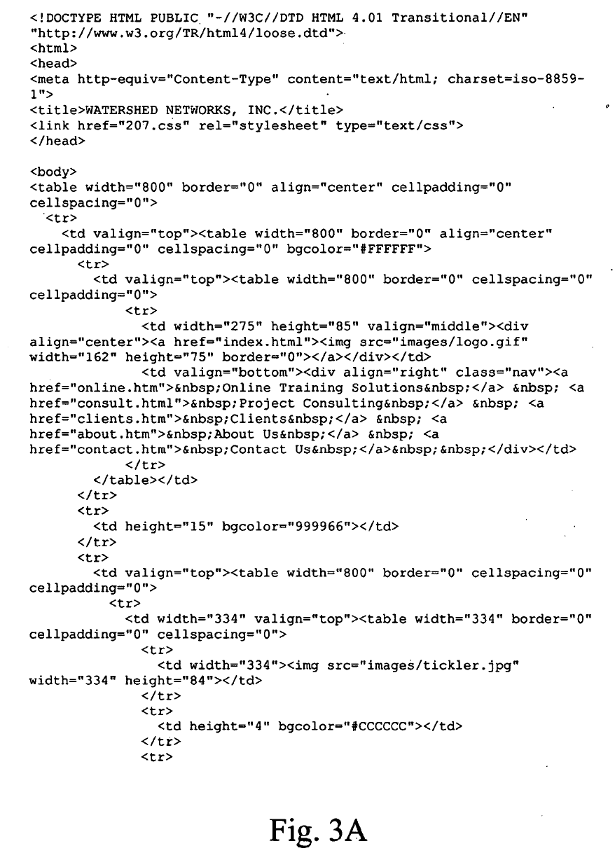

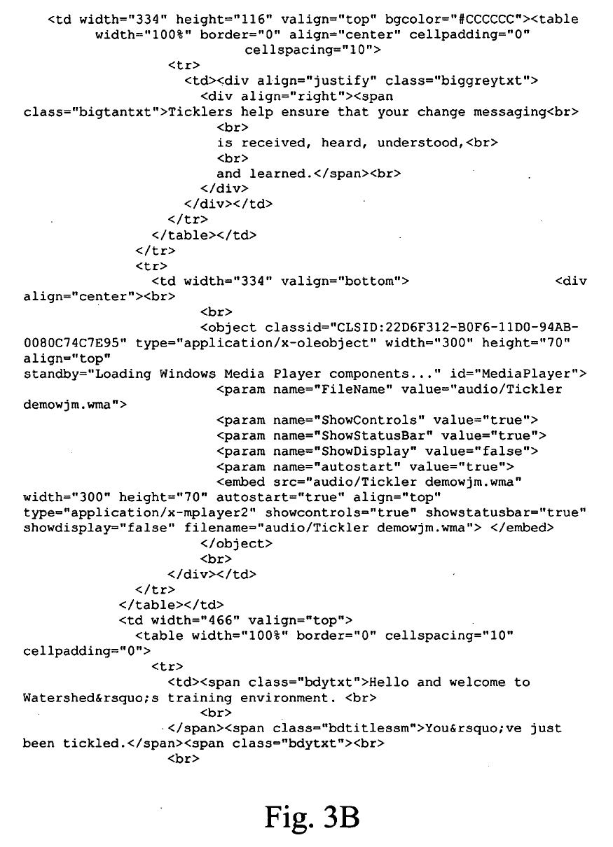

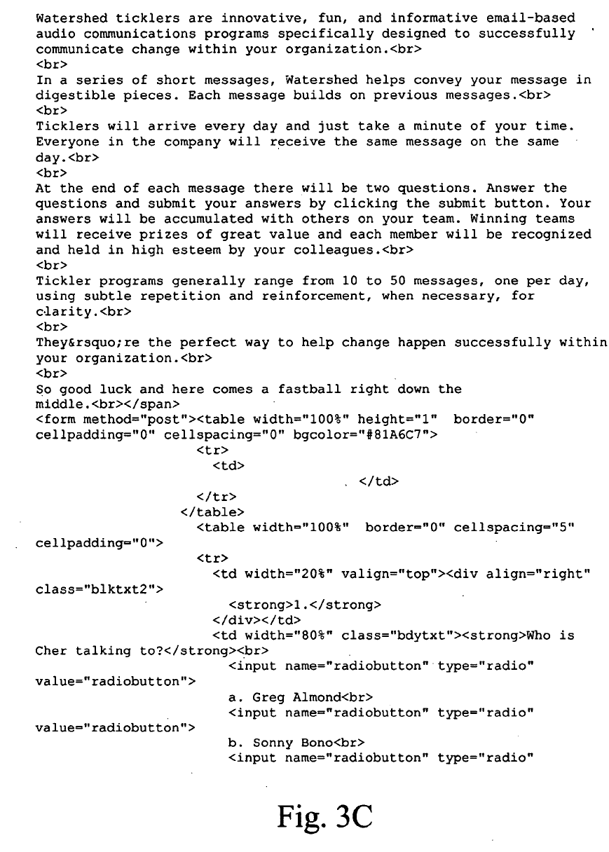

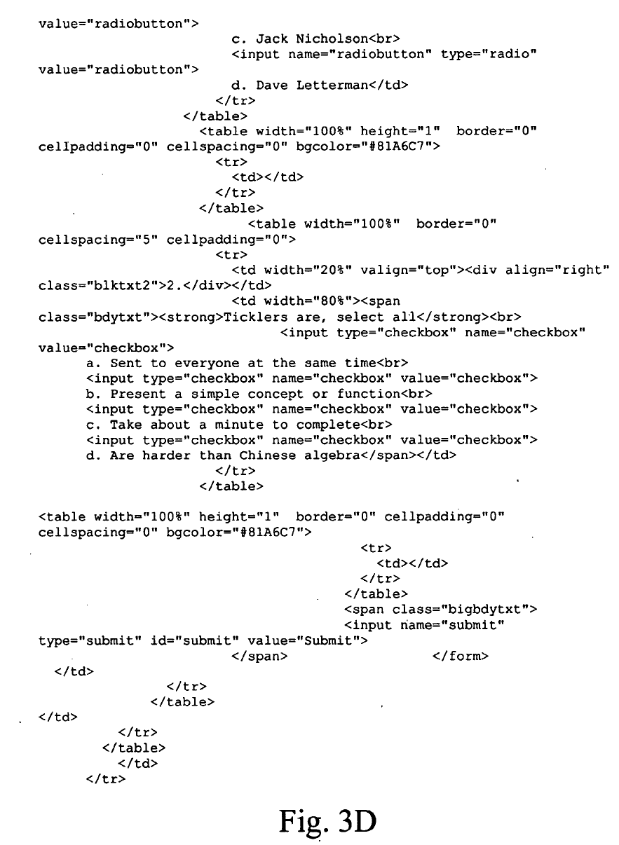

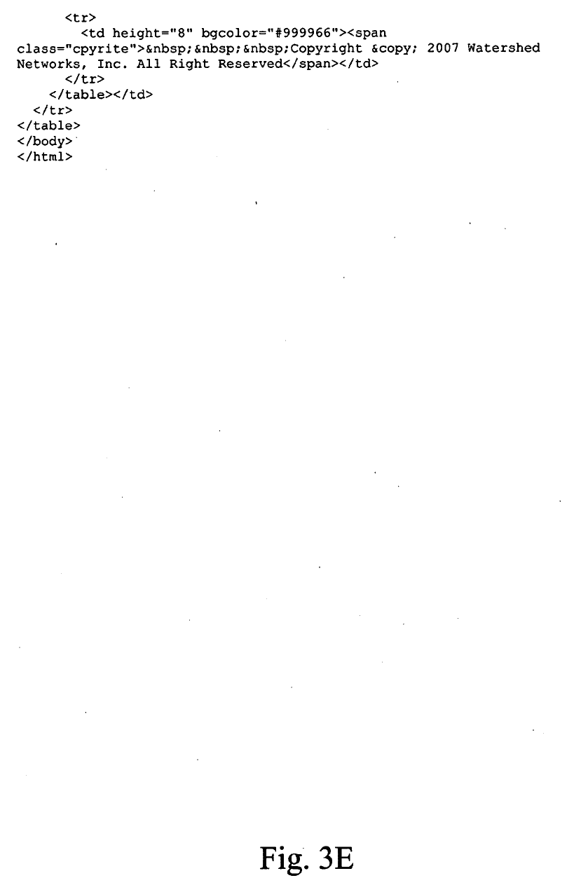

Referring to FIG. 2, a computer system embodying a software program 15 (e.g., a processor routine) of the present invention is generally shown at computer system 11. The computer system 11 employs a host processor 13 in which the operation of software programs 15 are executed (e.g., a program that allows for the steps of the methods described herein to be carried out). An input device or source such as on-line data or a database of the recipients destination addresses and the ticklers, provides input to the computer system 11 at 17. The input can be pre-processed by I/O processor 19 which queues and/or formats the input data, if necessary, as needed. The user inputted data is then transmitted to host processor 13 which processes the data through software 15. Using the input data, software 15 provides an output for either memory storage 21 or display through an I/O device, e.g., a workstation display monitor, PDA, media player (ipod, mp3 player)) and the like. I/O processing (e.g., formatting) of the content is provided at 23.

### Exemplification

The present invention was designed as follows. A series of ticklers were designed to enable the telecom companies to update and inform their employees on the reasons to transition to a new IP network business model. A series of 42 messages for the telecom company was designed and describe basic functions and concepts of the telephone network and the telephone network business model. The description was in elementary terms to insure comprehension as the entire employee universe is the audience. As each message is presented, it lays the foundation for something while providing subtle repetition on previous messages. The time interval between messages enables recipients to digest content and discuss with others.

The ticklers were short messages, usually 60 to 70 seconds, and conveys a simple concept or function. All employees received the same tickler on the same day. A series of ticklers were presented to all employees in succeeding days so that over the course of 7 to 8 weeks even the most complex issue were presented and understood.

The tickler arrived at the employees' location by their email address. The email provided a link to a server which contains the tickler for that particular day. The intent to deliver the same message to a large group of people is to promote discussion within the employees' work group whether at coffee breaks, lunch breaks, before meetings, etc. The tickler creates a buzz in the company as employees discuss the contents of the message and how the information relates to them and their function within the company. The next tickler arrived on the following day. This tickler summarized the information discussed yesterday and built upon that with a new concept or function, and so on. Since many employees have 30 to 40 email messages sent to their desks every day, ticklers use humor to draw the listener in. The tickler opened with several remarks designed to put a smile on their face. Once the user hears the humorous remarks they are then presented with 60 to 70 seconds of information which usually includes a graphic.

At the end of the tickler there were two questions. The first is a question about the humor and the second more important question was designed to assess the respondent's grasp of the concept. The answers were tracked on a server. The tracking information enables the company to organize teams in a competitive environment by offering prizes to the winning teams. An example of a prize, in one instance, may be the winning team gets the Wednesday before Thanksgiving off from work. The teams were created online in a manner such that employees can go online and track the progress of the winning teams. A competitive situation would provide incentives for teams to police participation in the program.

In another example, the present invention can be employed between when two companies are about to merge. In one company there are 20,000 employees. This company has its' own culture, processes, applications, etc. The other company is 30,000 employees. This company has its' own culture, processes, applications, etc. The leaders of these companies have to relay fears and apprehension about impending changes and reorient the workforce so that they are all pulling in the right direction. In such a case, the tickler is developed and sent to all 50,000 employees. First there would be a discussion about company A. Here is the financial info, products, markets, etc. Then there is company B. Here is the financial info, markets, etc. Then, the ticklers can be designed to explain why it makes good sense for the two companies to merge. Each employee would feel like they are in the loop and engaged in the process. Within about 35 to 40 messages the entire company would have an understanding of where we were, where they were, and why it makes sense for us to get together and move to this new place.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of disseminating information about a topic to more than one recipient, wherein the information comprises a plurality of informational segments, wherein an informational segment comprises one or more pieces of media, an image, text, or any combination thereof, the method comprises:
a. providing an electronic communication to said recipients, wherein the electronic communication comprises the informational segment or a link thereto, wherein the informational segment lasts about 3 minutes or less;
b. obtaining feedback from the user regarding the informational segment;
c. repeating steps a) and b) periodically until each informational segment is provided to more than one recipient, to thereby disseminate said information.

2. The method of claim 1, wherein the informational segment includes a comical element, informational element, and a request for feedback.

3. The method of claim 2, wherein the request for feedback comprises one or more questions regarding the information conveyed.

4. The method of claim 3, wherein the informational segment lasts about 1½ minutes or less.

5. The method of claim 1, wherein the information comprises at least about 20 informational segments.

6. The method of claim 5, wherein the informational segment conveys an aspect of the topic.

7. A method of disseminating information about a topic to more than one recipient, wherein the information comprises at least about 20 informational segments, wherein an informational segment conveys an aspect of the topic and comprises one or more pieces of media, an image, text, or any combination thereof, the method comprises:
a. providing an electronic communication to said recipients, wherein the electronic communication comprises the informational segment or a link thereto, wherein the informational segment lasts about 1½ minutes or less and further includes a comical element, informational element, and a request for feedback;
b. obtaining one or more answers to one or more questions regarding the informational element of the informational segment;
c. repeating steps a) and b) periodically until each informational segment is provided to more than one recipient, to thereby disseminate said information.

8. The method of claim 7, wherein steps a) and b) are repeated daily, every few days, bi-weekly, weekly, or a combination thereof.

9. The method of claim 8, further including the steps of:
a. assessing answers of one or more recipients to determine retention of the information, wherein one or more correctly answered questions indicates retention; and
b. modifying one or more informational elements of one or more segments to convey information not retained by one or more recipients.

10. The method of claim 9, further including logging in of the recipient.

11. The method of claim 10, wherein the link to the informational segment is provided, the method further includes:
a. engaging the link by the recipient; and
b. automatically logging in the recipient.

12. A computer system for disseminating information about a topic to more than one recipient, the system comprises:
a. a source of informational data comprises a plurality of informational segments, wherein an informational segment comprises one or more pieces of media, an image, text, or any combination thereof, and recipient data;
b. a processor, coupled to the source, wherein the processor carries out the steps that comprise:
i. providing an electronic communication to said recipients, wherein the electronic communication comprises the informational segment or a link thereto, wherein the informational segment lasts about 3 minutes or less;
ii. recording feedback from the user regarding the informational segment;
iii. repeating steps a) and b) periodically until each informational segment is provided to more than one recipient, to thereby disseminate said information. and
c. an output device that provides the informational segment.

13. The system of claim 12, wherein the link to the informational segment is provided, the processor further includes automatically logging in the recipient upon the recipient engaging the link.

14. The system of claim 13, wherein the source further includes recipient data that comprises name, login identification, destination address for the electronic communication, and any combination thereof.

15. The system of claim 14, wherein the destination of electronic communication comprises an email address or mobile phone number.
